(19) United States
(12) Patent Application Publication
(10) Pub. No.: US 2021/0371353 A1
(43) Pub. Date: Dec. 2, 2021

(54) FERTILIZER COMPOSITIONS AND PLANTS CONTAINING PROTOCATECHUIC ACID, AND USES THEREOF

(71) Applicant: Lanny L. JOHNSON, Frankfort, MI (US)

(72) Inventor: Lanny L. JOHNSON, Frankfort, MI (US)

(21) Appl. No.: 16/890,911

(22) Filed: Jun. 2, 2020

(51) Int. Cl. C05G 5/20; C05C 11/00; A01C 21/00; C05F 11/00

(52) U.S. Cl. CPC C05G 5/20; C05C 11/00; C07B 2200/13; C05F 11/00; A01C 21/005

(57) ABSTRACT

Fertilizer compositions containing protocatechuic acid are provided. Such fertilizer compositions may be used to fertilize plants or plant seeds. The use of such fertilizer compositions to fertilize plants or plant seeds can provide benefits to the plants, e.g., enhanced plant growth, less browning, greater pest resistance, and better flowering, as well as health benefits to consumers of those plants.

### FIELD

The present disclosure relates generally to fertilizer compositions, methods of using said fertilizer compositions, and plants treated with said methods. More specifically, the present disclosure relates to fertilizer compositions containing protocatechuic acid, methods of using said fertilizer compositions, and plants treated with said methods.

### BACKGROUND

There is a growing societal reluctance to accept Genetically Modified Organism (GMO) food. A GMO is any organism whose genetic material has been altered using genetic engineering techniques. Genetic engineering techniques can create combinations of plant, animal, bacteria, and virus genes that do not occur in nature or through traditional crossbreeding methods. Most packaged foods contain ingredients derived from corn, soy, canola, and sugar beet. The vast majority of those crops grown in North America are genetically modified. At present (2020) most GMO products are not required to be labeled as such in the US, which can be a concern for consumers.

Health-conscious consumers have a desire to avoid GMO and hormonally stimulated products, in fear of increased risk of cancer. On the other hand, the food industry has a desire to produce a product that is disease and drought tolerant, with increased yield, long shelf life, and an appealing appearance at a profit, which makes GMO and hormonally stimulated products appealing to the food industry. As a result, there has been a long-felt need to resolve this disparity between consumers and the food industry.

### BRIEF SUMMARY

The present disclosure addresses this long-felt need by providing fertilizer compositions containing protocatechuic acid. Such fertilizer compositions may be used to fertilize plants or plant seeds. The use of such fertilizer compositions to fertilize plants or plant seeds can provide benefits to the plants, e.g., enhanced plant growth, less browning, greater pest resistance, and better flowering, as well as health benefits to consumers of those plants.

In one aspect, provided are fertilizer compositions comprising protocatechuic acid. In some embodiments, fertilizer compositions are in solid form. In some variations, the fertilizer compositions comprise protocatechuic acid in crystal form (protocatechuic acid crystal). In some embodiments, the fertilizer compositions are liquid mixtures.

In another aspect, provided are methods for fertilizing a plant or part thereof using, providing, and/or applying a fertilizer composition described herein. In some embodiments, the methods include applying a fertilizer composition described herein to a plant or part thereof. In some embodiments, the plant or part thereof is a plant seed. In some embodiments, the methods include applying a fertilizer composition described herein to a plant seed. In some variations, the methods include soaking the plant seed in the fertilizer composition prior to seeding. In some variations, the methods include planting the plant seed in soil prior to applying the fertilizer composition. In some variations, the methods include (i) planting the plant seed in soil (prior to applying the fertilizer composition) and (ii) applying the fertilizer composition adjacent to or above the plant seed. In some variations, the methods include (i) planting the plant seed in soil and (ii) sprinkling the fertilizer composition adjacent to or above the plant seed, wherein protocatechuic acid in the fertilizer composition is in crystal form. In some variations, the methods include (i) planting the plant seed in soil and (ii) spraying the fertilizer composition adjacent to or above the plant seed.

In some embodiments, the plant or part thereof is a plant with one or more roots. In some variations, the methods include applying the fertilizer composition adjacent to or above one or more roots of the plant. In some variations, the methods include sprinkling the fertilizer composition adjacent to or above the one or more roots. In some variations, the methods include spraying the fertilizer composition adjacent to or above the one or more roots.

In some aspect, provided are plants or parts thereof treated with the methods described herein.

### DESCRIPTION OF THE FIGURES

The present application can be understood by reference to the following description taken in conjunction with the accompanying figures.

FIG. 1A depicts a commercial plant box used in Example 1, to evaluate the effect of protocatechuic acid on lettuce.

FIG. 1B depicts an illustration of how the plant box in FIG. 1A was partitioned and how experimental and control groups were placed in the plant box in Example 1, to evaluate the effect of protocatechuic acid on lettuce.

FIG. 2 depicts lettuce bunches harvested from experimental and control groups in Example 1 approximately eight weeks after sowing, to evaluate the effect of protocatechuic acid on lettuce growth and shape.

FIGS. 3A and 3B depict the cut ends of lettuce harvested from experimental groups 2 and 3 in Example 1, six days after harvesting (approximately eight weeks after sowing; see FIG. 2) and cutting, to evaluate the effect of protocatechuic acid on lettuce browning.

FIGS. 4A and 4B depict the lettuce leaves harvested from experimental group 3 in Example 1, six days after harvesting (approximately eight weeks after sowing; see FIG. 2) and cutting, to evaluate the effect of protocatechuic acid on lettuce browning.

FIGS. 5A and 5B depict lettuce bunches harvested from experimental groups 2 and 3 in Example 1 approximately 14 weeks after sowing, to evaluate the effect of protocatechuic acid on lettuce growth, shape, and resistance to pests.

FIGS. 6A and 6B depict two pots of pink azalea used in Example 3, to evaluate the effect of protocatechuic acid on the plant.

FIGS. 7A and 7B depict front and back images of experimental and control pink azalea pots in Example 3 approximately five weeks after placing PCA crystals in the experimental pot.

FIG. 8 depicts containers of spinach at the start of the first experiment (effect of PCA in various water types) in Example 4.

FIGS. 9A to 9C depict a side-by-side comparison of experimental containers and corresponding control containers in Example 4.

FIG. 10 depicts containers of spinach at the start of the second experiment (varying PCA dose) in Example 4.

FIGS. 11A and 11B depict a side-by-side comparison of experimental containers and corresponding control containers in Example 4.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

### Fertilizer Composition

In one aspect, provided are fertilizer compositions comprising protocatechuic acid. In some embodiments, fertilizer compositions are in solid form. In some variations, the fertilizer compositions comprise protocatechuic acid in crystal form (protocatechuic acid crystal). In some variations, the protocatechuic acid crystal is at least 80%, at least 90%, at least 95%, at least 98%, or at least 99% pure. In some variations, the protocatechuic acid crystal is 100% pure. In some variations, the protocatechuic acid crystal is in particulate form. In some embodiments, each particulate form of the protocatechuic crystal is less than 10 g, less than 5 g, less than 1 g, less than 100 mg, less than 10 mg, less than 1 mg, less than 100 μg, less than 10 μg, or less than 1 μg. In some variations, the protocatechuic acid crystal is biochemically produced. In some variations, the protocatechuic acid crystal is produced by a plant extraction method. In some variations, the protocatechuic acid crystal contains trace metal content less than 100 ppm, less than 10 ppm, less than 1 ppm, less than 100 ppb, less than 10 ppb, or less than 1 ppb.

In some embodiments, the fertilizer compositions are liquid mixtures. In some variations, protocatechuic acid in the fertilizer composition is partly or fully dissolved in a solvent. In some variations, protocatechuic acid in the fertilizer composition is partly dissolved in a solvent. In some variations, protocatechuic acid in the fertilizer composition is fully dissolved in a solvent. In some variations, the solvent is water. In some variations, the solvent is tap water. In some variations, the solvent is purified tap water. In some variations, the protocatechuic acid is between 0.01% and 0.5%, 0.1% and 0.5%, between 0.1% and 1%, between 0.5% and 1.5%, or between 0.75% and 1.25% of the fertilizer composition. In some variations, the protocatechuic acid is around 0.1%, around 0.5%, around 0.75%, around 1%, or around 1.24% of the fertilizer composition. In some variations, the protocatechuic acid is at least 0.01%, at least 0.1%, at least 0.5%, at least 1%, at least 1.2% of the fertilizer composition.

In some embodiments, fertilizer compositions further comprise cell broth, protein, or agricultural by-product, or any combination thereof. In some variations, the agricultural by-product is a by-product generated at a facility processing agricultural product.

In some embodiments, fertilizer compositions further comprise nitrogen, phosphorous, or potassium, iron, copper, zinc, manganese, or magnesium, or any combination thereof. In some variations, fertilizer compositions further comprise nitrogen. In some variations, molar concentration or molarity of protocatechuic acid in a fertilizer composition is at least 1.5 times, at least 2 times, at least 2.5 times, at least 4 times, at least 6 times, at least 10 times, at least 20 times, at least 50 times, or at least 100 times higher than molar concentration or molarity of iron, copper, zinc, manganese, and magnesium all combined in the fertilizer composition.

In some embodiments, molality of protocatechuic acid in a fertilizer composition is at least 1.5 times, at least 2 times, at least 2.5 times, at least 4 times, at least 6 times, at least 10 times, at least 20 times, at least 50 times, or at least 100 times higher than molality of iron, copper, zinc, manganese, and magnesium all combined in the fertilizer composition. For example, if molality of protocatechuic acid in a fertilizer composition is 80 mmol/kg and molality of iron, copper, zinc, manganese, and magnesium all combined in the fertilizer composition is 40 mmol/kg, then molality of protocatechuic acid in the fertilizer composition is 2 times higher than molality of iron, copper, zinc, manganese, and magnesium all combined in the fertilizer composition.

In some embodiments, molar concentration, molarity, molality, or total number of moles of protocatechuic acid in a fertilizer composition is at least 2 times higher than molar concentration, molarity, molality, or total number of moles of iron, copper, zinc, manganese, and magnesium all combined in the fertilizer composition. In some variations, molar concentration, molarity, molality, or total number of moles of protocatechuic acid in a fertilizer composition is higher than what is necessary to coordinate with or to form a complex with every metal element in the fertilizer composition, including iron, copper, zinc, manganese, and magnesium.

### Method of Fertilizing Plant

In another aspect, provided are methods for fertilizing a plant or part thereof using, providing, and/or applying a fertilizer composition described herein. In some embodiments, the methods include applying a fertilizer composition described herein to a plant or part thereof. In some embodiments, the plant or part thereof is a plant seed. In some embodiments, the methods include applying a fertilizer composition described herein to a plant seed. In some variations, the methods include soaking the plant seed in the fertilizer composition prior to seeding. In some variations, the methods include planting the plant seed in soil prior to applying the fertilizer composition. In some variations, the methods include (i) planting the plant seed in soil (prior to applying the fertilizer composition) and (ii) applying the fertilizer composition adjacent to or above the plant seed. In some variations, the methods include (i) planting the plant seed in soil and (ii) sprinkling the fertilizer composition adjacent to or above the plant seed, wherein protocatechuic acid in the fertilizer composition is in crystal form. In some variations, the methods include (i) planting the plant seed in soil and (ii) spraying the fertilizer composition adjacent to or above the plant seed.

In some embodiments, the plant or part thereof is a plant with one or more roots. In some variations, the methods include applying the fertilizer composition adjacent to or above one or more roots of the plant. In some variations, the methods include sprinkling the fertilizer composition adjacent to or above the one or more roots. In some variations, the methods include spraying the fertilizer composition adjacent to or above the one or more roots.

In some embodiments, the fertilizer composition comprises nitrogen, and the methods include applying the fertilizer composition in an amount corresponding to at least 0.01 lb nitrogen/1000 ft²/month, corresponding to at least 0.1 lb nitrogen/1000 ft²/month, corresponding to at least 0.25 nitrogen/1000 ft²/month, corresponding to at least 0.5 lb nitrogen/1000 ft²/month, corresponding to at least 1 lb nitrogen/1000 ft²/month, corresponding to at least 2 lb nitrogen/1000 ft²/month, corresponding to at least 3 lb nitrogen/1000 ft²/month, corresponding to at least 5 lb nitrogen/1000 ft²/month, corresponding to 0.1 to 1 lb nitrogen/1000 ft²/month, corresponding to 0.1 to 2 lb nitrogen/1000 ft²/month, corresponding to 0.25 to 3 lb nitrogen/1000 ft²/month, or corresponding to 1 to 5 lb nitrogen/1000 ft²/month.

In some embodiments, the methods for fertilizing a plant include combining the fertilizer composition with water to form an aqueous mixture prior to applying the fertilizer composition. In some variations, the methods for fertilizing a plant or part thereof include (i) providing a fertilizer composition described herein, (ii) combining the fertilizer composition with water to form an aqueous mixture, and (iii) supplying the aqueous mixture to the plant. In some variations, these methods are used in hydroponics.

In some embodiments, the fertilizer composition is injected into the plant. In some variations, the methods for fertilizing a plant or part thereof include (i) providing a fertilizer composition described herein, and (ii) injecting the fertilizer composition into the plant.

Plants Treated with Fertilizer Composition

In some aspect, provided is a plant or part thereof treated with the methods described herein. In some embodiments, the plant or part thereof contains at least 1 ppm, at least 2 ppm, at least 3 ppm, at least 5 ppm, at least 10 ppm, at least 20 ppm, or at least 50 ppm of protocatechuic acid. In some variations, leaves of the plant contain at least 1 ppm, at least 2 ppm, at least 3 ppm, at least 5 ppm, at least 10 ppm, at least 20 ppm, or at least 50 ppm of protocatechuic acid.

In some embodiments, the plant or part thereof contains at least 5%, at least 10%, at least 25%, at least 50%, or at least 75% more protocatechuic acid than a plant or part thereof not treated with the methods described herein. In some variations, the plant or part thereof contains at least 2 times, at least 3 times, at least 4 times, at least 5 times, at least 6 times, at least 7 times, at least 8 times, at least 9 times, at least 10 times, at least 15 times, or at least 20 times more protocatechuic acid than a plant or part thereof not treated with the methods described herein.

In some embodiments, the plants treated with the methods for fertilizing described herein are lettuce, azalea, or spinach. In some variations, the plants treated with the methods for fertilizing plants described herein are lettuce. In some variations, the plants treated with the methods for fertilizing described herein are pink or red azalea. In some variations, the plants treated with the method for fertilizing plants described herein are any plant species. In some variations, the plants treated with the method for fertilizing plants described herein are maize, oat, sorghum, grape, date, grapefruit, apple, kiwi, pomegranate, olive, almond, lentil, cauliflower, eggplant, chicory, onion, acai, avocado, bilberry, bitter melon, blackberry, blueberry, buckwheat, currant, garlic, gooseberry, juneberry, lingonberry, mango, mangosteen, medlar, mulberry, pear, raspberry, shallot, strawberry, cherry, or star anise. In some variations, the plants treated with the method for fertilizing plants described herein are Vitis vinifera, Ciboti umbarometz, Hibiscus sabdariffa, Hedera helix, Phyllanthus emblica, Saliva miltiorrhiza, Alpiniao xyphylla, Euterpeoleracea, Allium cepa, Oryza sativa, Cinnamomum aromaticum, Ginkgo biloba L., Prunusa mygdalus, Prunus domestica L., Agaricus bisporus, Phellinus linteus, Hibiscus sabdariffa, Boswelli adalzielii, Hypericum perforatum L., or Ribesuva crispa L.

### EXAMPLES

The presently disclosed subject matter will be better understood by reference to the following Examples, which are provided as exemplary of the invention, and not by way of limitation.

### Example 1

### Effect of Protocatechuic Acid on Lettuce

This example compares the effect of treating the soil adjacent to lettuce seeds with protocatechuic acid (PCA) at the time of seeding.

### Experimental and Control Groups:

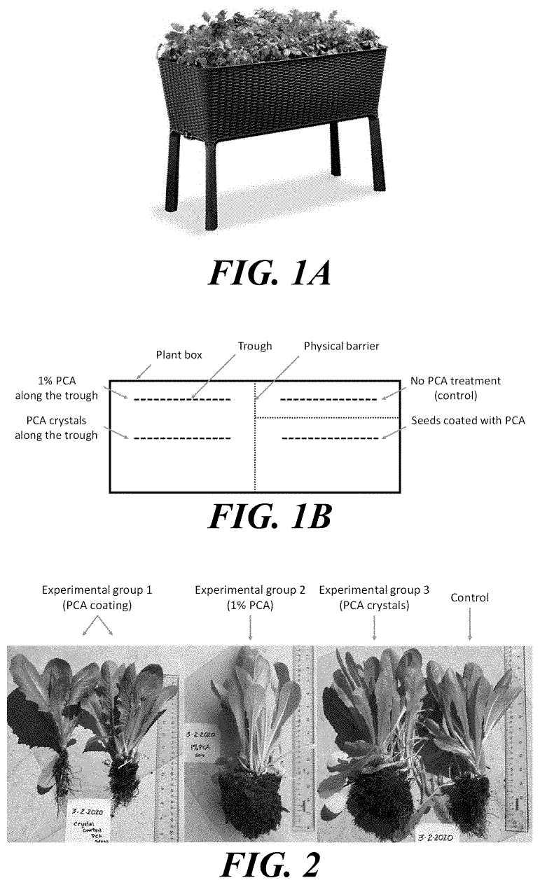

A commercial plant box as shown in FIG. 1A was used for the experiment. The bottom one half was filled with sandbox sand, and the top layer was filled with six inches of non-fertilized soil. The level of the soil was four inches below the top of the container. The plant box was partitioned into three sections with physical barriers in between, from the top of the soil to the bottom of the plant box, as illustrated in FIG. 1B.

A single straight line of 0.25-inch-deep trough was formed in each section. Then, lettuce seeds were placed in the trough according to the methods laid out in Table 1 below. Each section was watered daily with tap water.

TABLE 1
Treatment of each section.

| Name | Position | Treatment |
|---|---|---|
| Experimental | Lower | Lettuce seeds were coated with PCA crystals by |
| group 1 | right | physical contact. Then, the coated seeds were |
| | | placed in the trough, and the trough was covered |
| | | with adjacent soil. |
| Experimental | Upper | Lettuce seeds were placed in the trough. Then, |
| group 2 | left | the trough was watered with 15 mL of 1% PCA in |
| | | tap water, and the trough was covered with |
| | | adjacent soil. |
| Experimental | Lower | Lettuce seeds were placed in the trough. Then, 5 |
| group 3 | left | g of PCA crystals was sprinkled over the trough, |
| | | and the trough was covered with adjacent soil. |
| Control | Upper | Lettuce seeds were placed in the trough, and the |
| group | right | trough was covered with adjacent soil. The soil |
| | | and the seeds were not treated with any PCA. |

### PCA Content Analysis:

Approximately eight weeks after sowing, some of the soil and sprouted lettuce from each section (experimental groups 1-3 and control group) were harvested and frozen for PCA content analysis by LC-MS-MS. Table 2 below summarizes the PCA content in each sample.

Surprisingly, the leaves from experimental group 3 showed the highest PCA content of 9.88 ppm or 7.4 times more than those from the control group. The leaves from experimental group 2 showed slightly less PCA content, 8.95 ppm or 6.7 times more than those from the control group. This multi-fold increase in PCA content was unexpected.

TABLE 2
PCA contents in the leaves and soil taken from each
section approximately six weeks after sowing.

| | Component | PCA content | Relative to |
|---|---|---|---|
| Name | tested | (ppm) | control |
| Experimental group 1 | Soil | 2.96 | <14.8× |
| (PCA coating) | Leaf | 5.91 | 4.4× |
| Experimental group 2 | Soil | 3.36 | <16.8× |
| (1% PCA) | Leaf | 8.95 | 6.7× |
| Experimental group 3 | Soil | 5.87 | <29.4× |
| (PCA crystals) | Leaf | 9.88 | 7.4× |
| Control group | Soil | <0.2 | <1× |
| | Leaf | 1.34 | 1× |

### Size of Roots and Leaves:

Approximately eight weeks after sowing, a portion of each group was harvested, and size of the roots and leaves of the harvested lettuce was measured, as summarized in Table 3 below. Surprisingly, experimental groups treated with PCA had generally larger roots and leaves, indicating enhanced growth of the plants. Lettuce harvested from experimental groups 2 and 3, each treated with 1% PCA and PCA crystals, especially showed bigger roots and leaves than the control. These results were unexpected and surprising since (i) it had been reported that PCA had no effect on growth of some plant species, e.g., rice, and (ii) as shown in Example 4, PCA can have deleterious effect on some plant species under certain conditions.

As a side note, the lettuce harvested from experimental group 1 had root and leaves shaped differently than other groups: the root was relatively narrower, and the leaves were relatively wider and shorter, as compared in FIG. 2.

TABLE 3
Size of root and leaves of lettuce harvested from each section.

| | Root (as a whole) | | Leaves (each) | |
|---|---|---|---|---|
| Name | Length | Width | Length | Width |
| Experimental group 1 | 8-11 cm | 3-5 cm | 17-18 cm | 4-7 cm |
| (PCA coating) | | | | |
| Experimental group 2 | 16 cm | 11 cm | 23-24 cm | 3-6 cm |
| (1% PCA) | | | | |
| Experimental group 3 | 10 cm | 9 cm | 24 cm | 4-6 cm |
| (PCA crystals) | | | | |
| Control group | 8 cm | 6 cm | 20-21 cm | 3-5 cm |

### Browning:

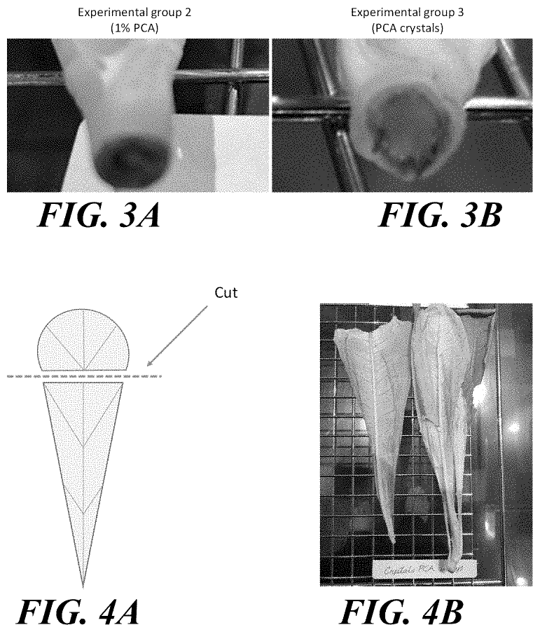

Browning of the lettuce harvested at approximately eight weeks after sowing were examined for experimental groups 2 and 3. The cut end of the stalk and the cut area on the leaves were observed. First browning appeared on the cut end six days after harvesting and cutting. The browning on these groups were not as thick as in the control group. The cut end of the stalk in experimental group 2 showed thicker dark ring compared to group 3, as shown in FIGS. 3A and 3B photographed six weeks after harvesting and cutting.

When the broader end of the leaf was cut as illustrated in FIG. 4A, no browning was observed in the cut areas of the leaves from experimental groups 3, six days after cutting. FIG. 4B shows a photograph taken six days after cutting a leaf from group 3.

### Remaining Lettuce:

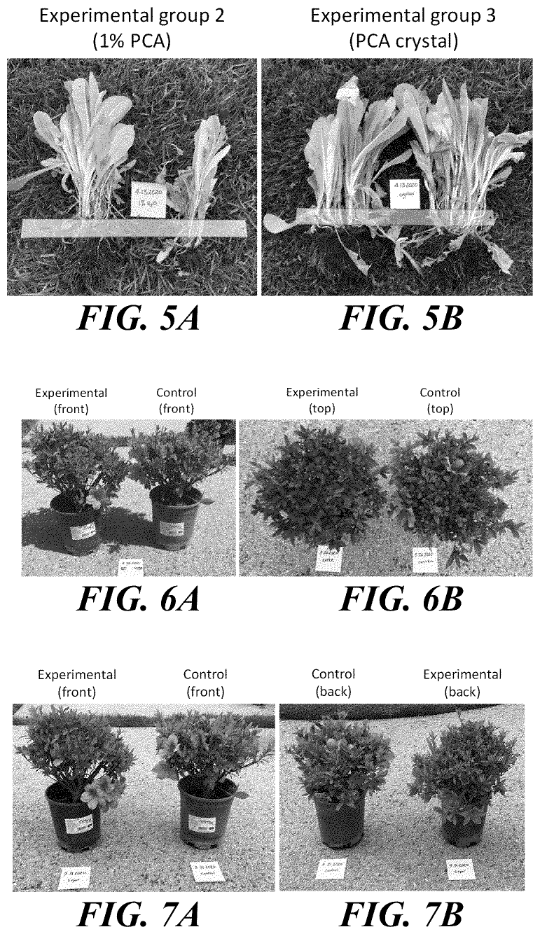

Plants is each group not harvested approximately eight weeks after sowing were observed for another six weeks before final harvesting. The leaves of experimental group 2 showed earlier wilting than those of experimental group 3. Further, as shown in FIGS. 5A and 5B, experimental group 3 achieved larger and wider leaves and larger roots than experimental group 2 when harvested. Finally, there were more holes in the leaves from experimental group 2 than in those from experimental group 3, which are known to be due to the imported cabbage worm, the diamondback caterpillar and cabbage looper.

### Conclusion

Analysis of soil and sprouted leaves approximately eight weeks after sowing showed that experimental groups treated with PCA had higher PCA content in the soil (more than 14.8, 16.8, and 29.4 times higher) and the leaves (4.4, 6.7, and 7.4 times higher) than the control group.

PCA placed in the soil with lettuce seeds at time of planting resulted in enhanced plant growth; larger root system and larger leaves than the control at two months post planting. The seeds coated with PCA prior to planting (experimental group 1) produced a different shaped single root (similar to that of a carrot), not the larger ball shape as seen in the control and the other two experimental groups.

In this harvest, plants from experimental groups 2 and 3 did not show thick brown covering on the stump, and no browning was seen where leaves were cut. The absence of browning provides improved plant produce appearance, and may provide longer shelf life for a commercial product. The reduction in browning on the cut ends and leaves in these experimental groups is likely due to the anti-tyrosinase effect of PCA.

The final examination approximately 14 weeks after sowing supported the PCA dose related anti-disease effect on the leaves, including more resistance to the holes in the plant due to the imported cabbage worm, the diamondback caterpillar and cabbage looper. Also, the taller and larger leaves produced by experimental group 3 was likely due to dose dependency. In addition, the earlier leaf wilting over prolonged growth in experimental group 2 (relative to experimental group 3) suggested dose dependency. The post-harvest examination showed clearly larger number of sprouts, wider and taller leaves, plus less holes in the leaves, which are further evidence of dose-related benefit.

### Example 2

### Effect of Protocatechuic Acid on Red Azaleas

This example examines the effect of protocatechuic acid (PCA) on flowering of red azaleas.

In one of the two azalea plants (red bird variety), small amount of PCA crystals were placed around the stem, and both were watered daily. The plant treated with PCA bloomed in three weeks, and the other plant bloomed in seven weeks. The plant treated with PCA flowered more than twice as fast.

### Example 3

### Effect of Protocatechuic Acid on Pink Azaleas

This example examines the effect of protocatechuic acid (PCA) on flowering and sprouting of pink azaleas.

Two pots of pink azaleas similar in width and height were used for this example, as shown in FIGS. 6A and 6B. In the experimental plant, small amount of PCA crystals were placed around the stem, and both plants were watered daily. Approximately five weeks after placing PCA crystals in the experimental pot, the experimental plant started to bloom before the control plant did, and had more flowers blooming than the control plant, as shown in FIGS. 7A and 7B. Approximately six weeks after placing PCA crystals, the control plant almost completely blossomed, but the experimental plant had many more buds on the top yet to flower. Approximately seven weeks after placing PCA crystals, the experimental plant continued to flower and had more buds and taller shoot of stems than the control, while the control plant wilted. In sum, the pink azalea treated with PCA flowered sooner, added sprouts sooner, and had budding that lasted longer than the control.

### Example 4

### Effect of Protocatechuic Acid on Spinach

This example examines the effect of protocatechuic acid (PCA) and water type on spinach.

### Effect of PCA in Various Water Types:

To assess the effect of PCA in various water vehicle types on spinach, 30 mL of 1% PCA in tap water, deionized water, or distilled water was injected into experimental groups 1-3 (see Table 4 below). Into corresponding control groups 1-3, 30 mL of tap water, deionized water, or distilled water without PCA was injected (see Table 4 below). Each group consisted of three small containers of spinach (Riverside species). The size of the container limited diffusion of the injected water volume.

TABLE 4
Condition of each group of three spinach containers.

Conditions

| Name | Volume (mL) | Content | Water type |
|---|---|---|---|
| Experimental | 30 | 1% PCA | Tap water |
| group 1 | | | |
| Experimental | | | Deionized water |
| group 2 | | | |
| Experimental | | | Distilled water |
| group 3 | | | |
| Control | | — | Tap water |
| group 1 | | | |
| Control | | | Deionized water |
| group 2 | | | |
| Control | | | Distilled water |
| group 3 | | | |

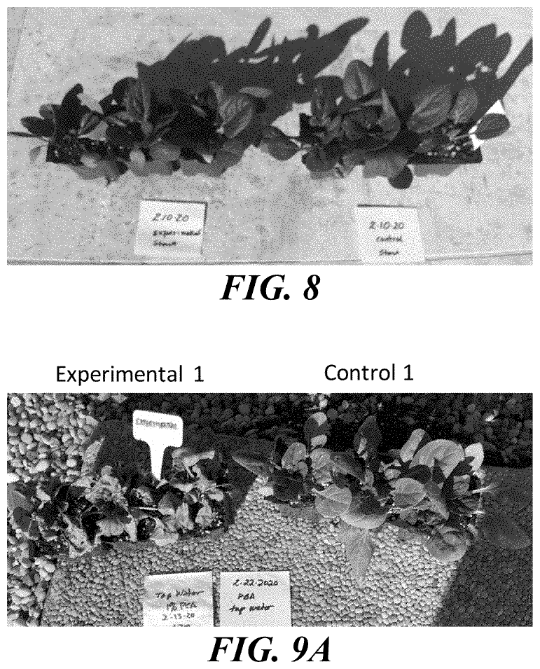

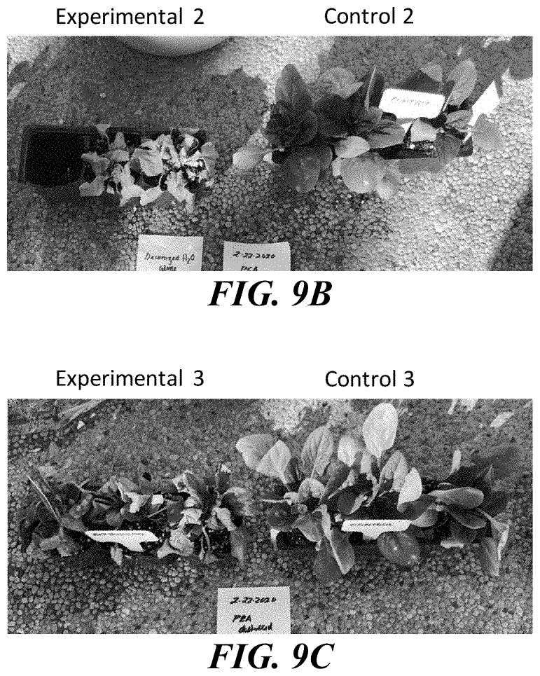

On the day of injecting 30 mL of liquid into the soil as described in Table 4, all containers had fresh spinach with no browning, as shown in FIG. 8. Within two weeks, experimental groups 1-1 to 1-3 all showed relatively severe browning and withering compared to the corresponding control groups, as shown in FIGS. 9A to 9C.

### Varying PCA Dose:

Recognizing the 30 mL volume of water was excessive for the container, the following study was performed with less volume. Deionized water was excluded based upon past negative effects. To assess the effect of PCA dose and water type on spinach, 5, 10, or 20 mL of 1% PCA in tap water or distilled water was injected into soil of experimental containers 1-6 (see Table 5 below). Into corresponding control containers 1-6, 5, 10, or 20 mL of tap water or distilled water without PCA was injected (see Table 5 below).

TABLE 5
Condition of each spinach container.

| | Conditions | | |
|---|---|---|---|
| Name | Volume (mL) | Content | Water type |
| Experimental | 5 | 1% PCA | Tap water |
| container 1 | | | |
| Experimental | 10 | | |
| container 2 | | | |
| Experimental | 20 | | |
| container 3 | | | |
| Experimental | 5 | | Distilled water |
| container 4 | | | |
| Experimental | 10 | | |
| container 5 | | | |
| Experimental | 20 | | |
| container 6 | | | |
| Control | 5 | — | Tap water |
| container 1 | | | |
| Control | 10 | | |
| container 2 | | | |
| Control | 20 | | |
| container 3 | | | |
| Control | 5 | | Distilled water |
| container 4 | | | |
| Control | 10 | | |
| container 5 | | | |
| Control | 20 | | |
| container 6 | | | |

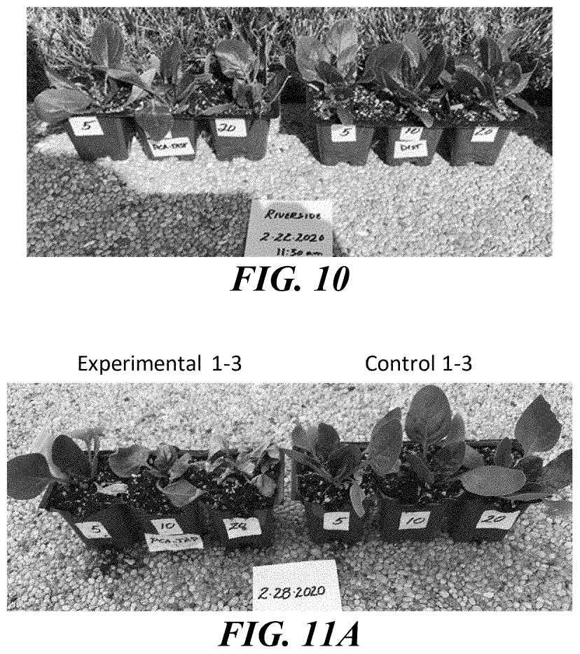

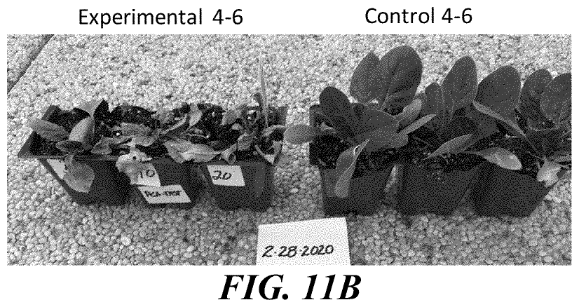

On the day of injecting the liquid as described in Table 5, all containers had fresh spinach with no browning, as shown in FIG. 10. Within a week, experimental containers 1-6 all showed more severe browning and/or withering compared to the corresponding control containers, as shown in FIGS. 11A and 11B. Approximately seven weeks after injecting the liquid to each container, experimental containers 1-3 regrew the plant, while experimental containers 4-6 did not. Thus, tap water was to be preferred with this specific spinach plant.

1. A fertilizer composition comprising protocatechuic acid, wherein the fertilizer composition is a liquid mixture, the protocatechuic acid is least 1% of the fertilizer composition, and the fertilizer composition further comprises cell broth, protein, or agricultural by-product, or any combination thereof.

2. The fertilizer composition of claim 1, wherein the protocatechuic acid is in crystal form.

3. (canceled)

4. (canceled)

5. (canceled)

6. The fertilizer composition of claim 1, further comprising nitrogen, phosphorous, potassium, iron, copper, zinc, manganese, or magnesium, or any combination thereof.

7. The fertilizer composition of claim 6, wherein molality of the protocatechuic acid is at least 2 times higher than molality of iron, copper, zinc, manganese, and magnesium combined.

8. A method for fertilizing a plant or part thereof, comprising applying a fertilizer composition of claim 1 to the plant or part thereof.

9. The method of claim 8, wherein the plant or part thereof is a plant seed.

10. The method of claim 9, further comprising soaking the plant seed in the fertilizer composition prior to seeding.

11. The method of claim 9, further comprising planting the plant seed in soil prior to applying the fertilizer composition.

12. The method of claim 8, wherein the plant or part thereof is a plant with one or more roots.

13. The method of claim 12, wherein the fertilizer composition is applied adjacent to or above the one or more roots.

14. The method of claim 8, wherein the fertilizer composition comprises nitrogen.

15. The method of claim 14, wherein the fertilizer composition is applied in an amount corresponding to 0.25 to 3 lb nitrogen/1000 ft²/month.

16. The method of claim 8, further comprising combining the fertilizer composition with water to form an aqueous mixture prior to applying the fertilizer composition.

17. The method of claim 16, wherein the method is used in hydroponics.

18. The method of claim 8, wherein the fertilizer composition is injected into the plant.

19. A plant or part thereof treated with the method of claim 8, comprising at least 1 ppm of protocatechuic acid in the plant or part thereof.

20. (canceled)

21. The fertilizer composition of claim 1, wherein the protocatechuic acid is between 1% and 1.25% of the fertilizer composition.

22. The method of claim 16, wherein the plant or part thereof is a plant seed and further comprising soaking the plant seed in the aqueous mixture prior to seeding.

23. The plant or part thereof of claim 19, wherein the protocatechuic acid in the plant or part thereof is between 5 ppm and 50 ppm.

24. The plant or part thereof of claim 19, wherein the protocatechuic acid in the plant or part thereof is between 5% and 75% more than a plant not treated with the method of claim 8.

25. The plant or part thereof of claim 19, wherein the protocatechuic acid in the plant or part thereof is between 2 times more and 20 times more than a plant not treated with the method of claim 8.
